(19) United States
(12) Patent Application Publication
(10) Pub. No.: US 2006/0163754 A1
(43) Pub. Date: Jul. 27, 2006

(54) Humidifier

(76) Inventors: Stephen Barthelson, Byhalia, MS (US); Francisco J. Carbajal, Arlington, TN (US); Glennbruce S. Campbell, Memphis, TN (US)

Correspondence Address: BAKER, DONELSON, BEARMAN,;CALDWELL & BERKOWITZ, P.C., 5 CONCOURSE PARKWAY, STE. #900, ATLANTA, GA, 30328, US

(21) Appl. No.: 11/043,325

(22) Filed: Jan. 26, 2005

(51) Int. Cl. B01F 3/04

(52) U.S. Cl. 261/30; 261/91

(57) ABSTRACT

A humidifier (10) is provided having a housing (11), a conventional electric motor (12), a fan blade assembly (13), a conical suction tube (14), and a cylindrical water droplet diffusing screen (15) mounted concentrically about the suction tube. The housing defines a downward air channel (32) commencing at an air inlet (33) and which extends about the bottom edge (34) of a barrier to an upward air channel (37) terminating at an air outlet (38). The suction tube has a bottom opening (22) through which water may enter the interior space of the suction tube and a series of water outlets (23). The housing has a lower housing portion (25) which defines a water reservoir (28) adapted to hold a supply of water having a maximum water line (MWL). In use, water is drawn through the suction tube and expelled into the downward air channel as droplets. These droplets travel downwardly along the downward air channel wherein the airstream is then diverted upwardly, thereby causing heavier droplets to be withdrawn from the airstream. As the airstream continues upwardly within the upward air channel the heavier remaining droplets are also withdrawn from the airstream. As a result, the airstream exiting the humidifier contains only the smallest water droplets.

### TECHNICAL FIELD

This invention relates to humidifiers, and specifically to cool mist type humidifiers.

### BACKGROUND OF THE INVENTION

During the winter months, many different types of known heating systems dry the air in a home. This often results in the inhabitants of the home developing one or more problems including dry skin, scratchy throats and long term coughs. In addition, the contents of the home may lose moisture which may cause furniture to creak, floors to squeak and a build-up of static electricity.

Proper introduction of indoor humidification may alleviate many of the problems associated with an air drying heating system and provide for a more comfortable “feel” and thereby, better living conditions. Various attempts have been made, through different humidification systems, to reintroduce moisture into the air within a dry air home.

A common type of humidifier includes a conical tube which draws water from a reservoir, as shown in U.S. Pat. Nos. 3,294,376; 3,283,478; and 5,514,303, the teachings of which are incorporated herein. This type of humidifier creates a cool mist by drawing water up through the tube through centrifugal force and expelling the water through an orifice at the top of the tube to create water droplets. These droplets may be directed onto a diffusor screen which breaks up the droplets into smaller droplets. The droplets are then blown into an airstream created by an internal fan. A common problem associated with these cool mist type humidifiers is that the droplets are carried by the airstream where they are then deposited upon furniture or other objects within the room. The eventual evaporation of these droplets upon the furniture leaves a white mineral deposit which is unsightly and therefore must be removed periodically.

Accordingly, it is seen that a need remains for a cool mist humidifier which overcomes problems associated with that of the prior art. It is to the provision of such therefore that the present invention is primarily directed.

### SUMMARY OF THE INVENTION

In a preferred form of the invention, a humidifier comprises a housing defining a water reservoir configured to provide a select maximum water level, an air intake, an air outlet, and an air channel extending between the air intake and the air outlet. The air channel has a downward channel portion, an upward channel portion, and a junction portion extending between the downward channel portion and the upward channel portion. The junction channel portion is positioned above the reservoir select maximum water level. The humidifier also has a motorized fan positioned to create an airflow through the air channel from the air intake to the air outlet, a rotatable suction tube having a lower end extending into the reservoir below the select maximum water level and an upper end positioned opposite the lower end. The upper end has at least one water outlet positioned within the downward channel portion above the junction channel portion. With this construction, water droplets expelled from the suction tube water outlet are dispersed within the airstream passing through the downward channel portion, and the transition of the airstream from a downward flow into the junction channel portion causes heavier droplets to be removed from the airstream.

### BRIEF DESCRIPTION OF THE DRAWING

FIG. 1 is a side view of the humidifier, shown in partial cross-section, embodying principles of the invention in a preferred form.

FIG. 2 is partial cross-sectional side view of a portion of the humidifier of FIG. 1.

FIG. 3 is a perspective view of a portion of the humidifier of FIG. 1.

### DETAILED DESCRIPTION

With reference next to the drawings, there is shown a humidifier 10 embodying principles of the invention in a preferred form. The humidifier 10 has a housing 11, a conventional electric motor 12 coupled to a conventional electric power source, a fan blade assembly 13 coupled to the electric motor 12, a conical suction tube 14 coupled to the electric motor 12 through the fan blade assembly 13, and a cylindrical water droplet diffusing screen 15 mounted concentrically about the suction tube 14.

The motor 12 is encased within a motor housing 17 having a top surface 18 to which conventional humidifier electronics may be coupled, such as the motor speed switch, desired humidification level, on/off switch and other similar electronics. The motor housing 17 is configured to extend flush with a central hub 19 of the fan blade assembly 13.

The suction tube 14 is coupled to the bottom of the fan blade assembly central hub 19. The suction tube 14 has a bottom opening 22 through which water may enter the interior space of the suction tube, and a series of water outlets 23 adjacent the central hub 19.

The housing 11 has a lower housing portion 25 and an upper housing portion 26. The lower housing portion 25 has an outer shell 27 configured to define a water reservoir 28 adapted to hold a supply of water having a maximum water line MWL. The lower housing portion 25 also includes a cylindrical central tube 31 in which the motor housing 17 is concentrically positioned to create an annular downward air channel 32 therebetween commencing at an air inlet 33. The central tube 31 extends to a larger diameter cylindrical portion 35 which creates a barrier which terminates at a bottom edge 34 and includes an annular array of secondary diffusing walls 36 positioned above the bottom edge 34. It should be understood that the bottom edge 34 is positioned above the maximum water line MWL of the water supply WS. The central tube 31 and a portion of the upper housing portion 26 are spaced away from the outer shell 27 of the lower housing portion 25 so as to define an upward air channel 37 therebetween extending continuously from the downward air channel 32, however as the air flows below the central tube 31 this portion may be termed a junction portion of the air channel between the downward air channel and the upward air channel. The upward air channel 37 terminates at an annular exhaust port or outlet 38. It should be understood that the sidewalls of the outer shell 27 extend directly to the portion of the lower housing which defines the water reservoir 28, so that any moisture collected upon the interior surface of the outer shell flows back into the water reservoir.

The upper housing portion 26 defines a water tank 39 adapted to contain the water supply WS. The water tank 39 includes a fill port and a conventional water release valve 41 which controls the flow of water from the water tank 39 to the water reservoir 28 to maintain a water level generally coinciding with the maximum water line MWL. The fill port may be part of the water release valve 41, as conventionally known in the art.

In use, the water tank 39 is filled with water and positioned upon the lower housing portion 25 so as to actuate the release valve to allow a portion of the water to flow from the water tank 39 to the water reservoir until it reaches its maximum water line MWL. As the bottom end of the suction tube 14 is positioned below the maximum water line MWL water enters the suction tube 14 through the bottom opening 22.

An operator may then actuate the on/off switch and set the desired level of humidification and motor speed, thereby energizing the electric motor 12. The energization of the electric motor 12 causes the rotation of the fan assembly 13 and suction tube 14. The rotation of the suction tube 14 causes water within the bottom end of the suction tube to be forced upwardly along the interior of the suction tube 14 through centrifugal force and the configuration of the expanding interior surface of the suction tube. As the water reaches the top end of the suction tube it is expelled through the water outlets 23 as high velocity water drops D. As the drops D travel horizontally from the suction tube the majority of the drops collide with the diffusing screen 15, thereby causing the drops D to be broken into smaller droplets DL as they pass through the diffusing screen and into the downward air channel 32. Some drops D however pass unencumbered through the diffusing screen 15. These drops D directly contact the secondary diffusing walls 36, whereby they too are broken into smaller droplets DL within the downward air channel 32. Also, the smaller droplets DL created by contact with the diffusing screen 15 may also be further broken up into even smaller droplets through contact with the secondary diffusing walls 36.

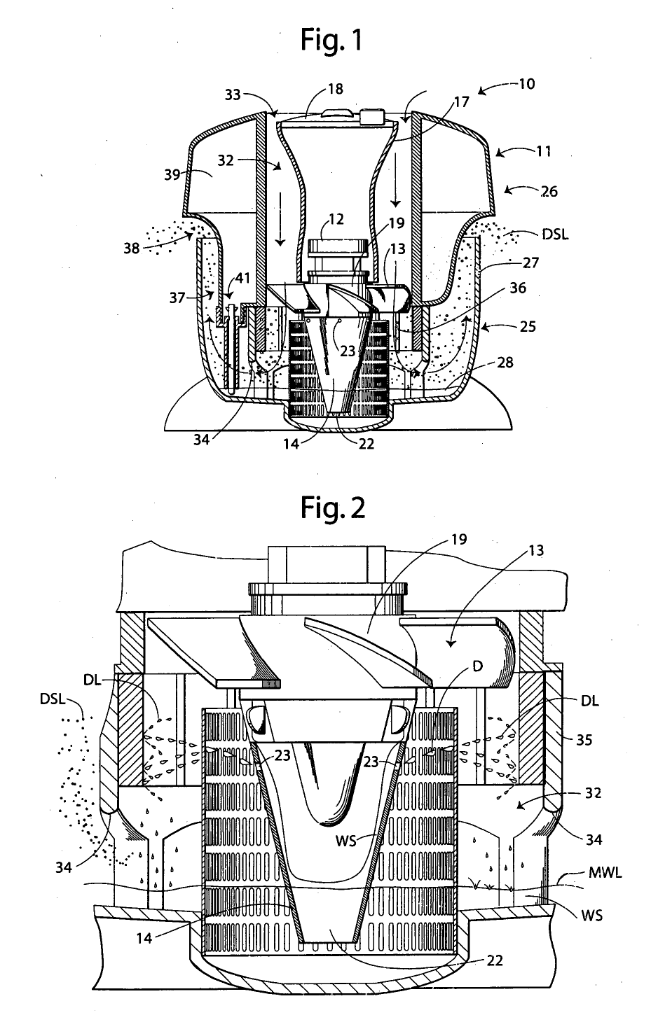

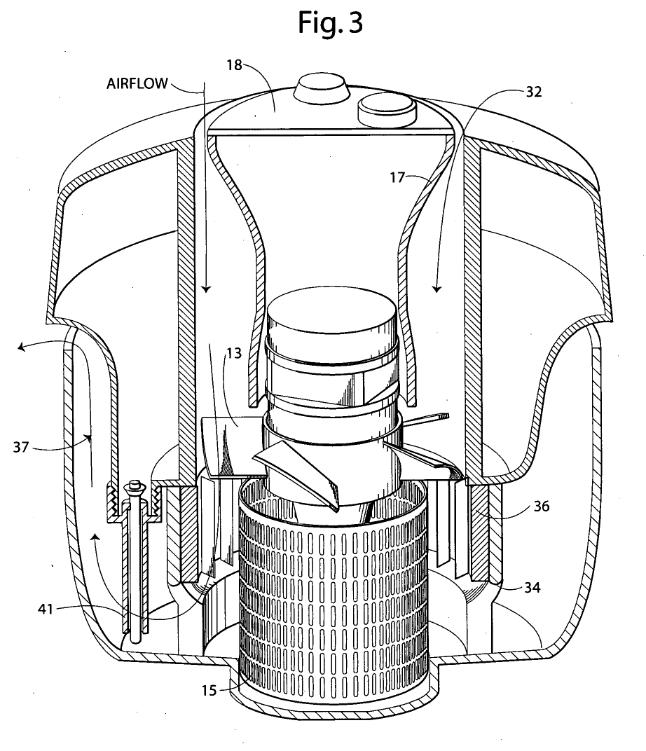

The rotation of the fan blade assembly 13 causes air to be drawn through the air inlet 33, through the downward air channel 32, through the upward air channel 37, and out of the air outlet 38 as shown by the directional arrows in FIG. 1. The airstream passing through the downward air channel 32 carries or entrains the droplets DL downwardly toward the water reservoir 28 before passing about the bottom edge 34 and into the upward air channel 37. The inertia of larger sized small droplets causes these droplets traveling downward within the downward air channel to continue into the water reservoir 28, while smaller sized droplets SDL continue to be entrained in the airstream and thereby flow with the airstream into the upward air channel 37. As the airstream flows through the upward air channel 37 larger sized small droplets are too heavy to be carried upwardly by the airstream and therefore these larger droplets fall upon the interior surface of the outer shell 27. These droplets flow down the interior surface where they are collected back into the water reservoir 28. Therefore, only the smallest of the droplets SDL are able to remain entrained in the airstream passing completely through the upward air channel 37 and out of the humidifier to ambience through the exhaust outlet 38. These droplets are so small in size that they evaporate into ambient air extremely fast, and therefore they do not eventually settle upon furniture and the like before evaporating. The evaporation of the droplets virtually eliminates the creation of mineral deposits associated with cool mist humidifiers, while still maintaining an excellent humidification of the ambient air.

It should be understood that the motor may be utilized with either a d.c. or an a.c. current. Also, it should be understood that the present invention is not limited to the annular air channels shown in the preferred embodiment. The air channel may be of any configuration so long as the entrained water droplets within the airstream flow downwardly prior to flowing upwardly.

It should also be understood that other types of water droplet generating devices may be utilized with the present invention, such as ultrasonic generators, vibrating devices, pressurized spray nozzles and the like.

It thus is seen that a humidifier is now provided which overcomes problems with those of the prior art. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. A humidifier comprising:
a housing defining a water reservoir configured to provide a select maximum water level, an air intake, an air outlet, and an air channel extending between said air intake and said air outlet, said air channel having a downward channel portion, an upward channel portion, and a junction portion extending between said downward channel portion and said upward channel portion, said junction channel portion being position above said reservoir select maximum water level;
a motorized fan positioned to create an airflow through said air channel from said air intake to said air outlet; and
a rotatable suction tube having a lower end extending into said reservoir below said select maximum water level and an upper end positioned opposite said lower end, said upper end having at least one water outlet positioned within said downward channel portion above said junction channel portion,
whereby water droplets expelled from the suction tube water outlet are dispersed within the airstream passing through the downward channel portion, and whereby the transition of the airstream from a downward flow into the junction channel portion causes heavier droplets to be removed from the airstream.

2. The humidifier of claim 1 wherein said suction tube is rotatably coupled to said motorized fan.

3. The humidifier of claim 1 further comprising a diffusing screen positioned adjacent said suction tube water outlet.

4. The humidifier of claim 1 further comprising a diffusing wall partially defining said downward channel portion.

5. The humidifier of claim 3 further comprising a diffusing wall partially defining said downward channel portion.

6. A humidifier comprising, an electric motor;
a fan assembly rotatably coupled to said motor;
a suction tube rotatably coupled to said motor, said suction tube having a water inlet adjacent a bottom end and a water outlet adjacent a top end; and
a housing defining an interior water reservoir configured to hold a supply of water immersing said bottom end of said suction tube, said housing also having an air inlet in fluid communication with said fan assembly, an air outlet, a downward air channel in fluid communication with said air inlet and oriented to direct an airstream flowing from said air inlet to said air outlet in a downwardly direction, and an upward air channel in fluid communication with said air outlet and oriented to direct and airstream flowing from said air inlet to said air outlet in an upwardly direction, said downward air channel being partially separated from said upward air channel by a barrier below which the airflow must pass in order to flow from said downward air channel into said upward air channel.

7. The humidifier of claim 6 wherein said water reservoir is position directly below said barrier.

8. The humidifier of claim 6 further comprising a diffusing screen positioned adjacent said suction tube water outlet.

9. The humidifier of claim 6 further comprising a diffusing wall partially defining said downward air channel.

10. The humidifier of claim 9 further comprising a diffusing wall partially defining said downward channel portion.

11. A humidifier comprising:
a housing defining a water reservoir, an air inlet, an air outlet, and an air channel extending between said air inlet and said air outlet, said air channel having a first portion oriented to direct an airstream flowing towards said air outlet in a downwardly direction and a second portion oriented to direct an airstream flowing towards said air outlet and downstream of said first portion in an upwardly direction;
an electric motor;
a fan assembly rotatably coupled to said motor and positioned to create an airstream through said air channel from said air inlet to said air outlet; and
a water droplet generating device positioned to produce water droplets within said air channel first portion,
whereby water droplets formed by the water droplet generating device are dispersed within the airstream passing through the air channel first portion, and whereby the transition of the airstream from a downwardly flow within the first portion to an upwardly flow within the second portion causes the heavier water droplets to be removed from the airstream.

12. The humidifier of claim 11 further comprising a diffusing screen positioned adjacent said suction tube water outlet.

13. The humidifier of claim 11 further comprising a diffusing wall partially defining said air channel first portion.

14. The humidifier of claim 13 further comprising a diffusing wall partially defining said air channel first portion.

15. The humidifier of claim 11 wherein said water droplet generating device is a rotating suction tube.
